(19) United States
(12) Patent Application Publication
(10) Pub. No.: US 2026/0054647 A1
(43) Pub. Date: Feb. 26, 2026

(54) SIDE MIRROR CAMERA MONITORING

(71) Applicant: GM Global Technology Operations LLC, Detroit, MI (US)

(72) Inventors: Manoj Kumar Sharma, Troy, MI (US); Julien P. Mourou, Bloomfield Hills, MI (US); Jonglee Park, Novi, MI (US); Charles R. Quinn, Pleasant Ridge, MI (US)

(21) Appl. No.: 18/809,901

(22) Filed: Aug. 20, 2024

(51) Int. Cl. H04N 17/00; B60R 1/26; G06V 10/74; G06V 10/82; G06V 10/98; G06V 20/58; H04N 7/18

(52) U.S. Cl. CPC B60R 1/26; G06V 10/98; G06V 20/58; B60R 2300/8046; G06V 10/761; G06V 10/82; G06V 2201/08

(57) ABSTRACT

A vehicle includes a rear view camera system including a camera mounted to a side of the vehicle, the camera defining a rear facing field of view. A screen is viewable from a driver's position in the vehicle and is configured to display an image feed captured by the camera. At least a portion of the vehicle is within the rear facing field of view. The portion of the vehicle within the rear facing field of view includes at least one distinguishable vehicle feature fixedly mounted to the vehicle relative to the rear view camera. A controller includes a memory and a processor, with the memory storing instructions configured to cause the controller to operate at least one quality assurance subprocess in real time and configured to cause the controller to notify the driver in response to at least one quality control metric determination.

The subject disclosure relates to vehicles, and in particular to rear facing side mirror camera systems.

Vehicles include one or more rear facing side mirrors. The rear facing side mirrors provide a rear facing view of the side of the vehicle on which the mirror is mounted without requiring the vehicle operator to fully turn their head away from the road. The rear facing view facilitates safely engaging in numerous vehicle operations including lane changes, overtaking, turning, etc.

In some cases, vehicles may replace one or more of the traditional style mirrors with a rear facing camera and a corresponding display in order to provide a better view than can be achieved using a mirror. By way of example, the camera may be positioned such that aspects that are obstructed in a mirror view are visible or may include a broader field of view than is achievable using mirror. Alternatively, similar camera placements may be used in addition to mirrors, with the resulting images supplementing the views provided directly by the mirrors.

Typically, the screen displaying the rearview image is not tied to the physical location of the camera in the way that a mirror is. As a result, the screen displaying the view may be positioned within the vehicle at a location remote from the camera and where the driver can view the rear view screen without diverting attention from the roadway in front of the vehicle.

It is desirable to provide a side mounted rear view camera that generates an accurate real-time image of the rear view, thereby allowing the camera system to replace the rear view mirror functions.

### SUMMARY

In one exemplary embodiment a vehicle includes a rear view camera system including a camera mounted to a side of the vehicle, the camera defining a rear facing field of view. A screen is viewable from a driver's position in the vehicle and is configured to display an image feed captured by the camera. At least a portion of the vehicle is within the rear facing field of view. The portion of the vehicle within the rear facing field of view includes at least one distinguishable vehicle feature fixedly mounted to the vehicle relative to the rear view camera. A controller includes a memory and a processor, with the memory storing instructions configured to cause the controller to operate at least one quality assurance subprocess in real time and configured to cause the controller to notify the driver in response to at least one quality control metric determination.

In addition to one or more of the features described herein the at least one quality assurance subprocess includes a frozen image monitoring subprocess.

In addition to one or more of the features described herein the frozen image monitoring subprocess is configured to determine a semantic similarity between a first image and a subsequent image using a frozen image subprocess.

In addition to one or more of the features described herein the subsequent image is immediately subsequent the first image.

In addition to one or more of the features described herein the subsequent image is subsequent to the first image by a delay of a plurality of intervening images.

In addition to one or more of the features described herein the frozen image subprocess includes providing the first image as an input to a first neural network and providing the second input to a second neural network and comparing an output of the first neural network to an output of the second neural network.

In addition to one or more of the features described herein the first neural network and the second neural network are identically trained neural networks having exactly the same parameters and the same weights for those parameters.

In addition to one or more of the features described herein the output of the first neural network is a first vector and the output of the second neural network is a subsequent vector.

In addition to one or more of the features described herein the at least one quality assurance subprocess includes a latency monitoring subprocess configured to detect a latency of an image feed provided from the camera by comparing an expected number of images in the image feed during a predetermined time window to an actual number of images received at the controller from the camera in the predetermined time window.

In addition to one or more of the features described herein the latency monitoring subprocess is configured to cause the controller to notify the driver in response to a latency exceeding an acceptable latency threshold.

In addition to one or more of the features described herein the at least one quality assurance subprocess includes a camera position and orientation monitoring subprocess configured to detect a deviation of the actual position and orientation of the camera from an expected position and orientation of the camera.

In addition to one or more of the features described herein the camera position and orientation monitoring subprocess is configured to detect a deviation of an actual camera position and orientation from an expected camera position and orientation by comparing an expected position of the at least one distinguishable vehicle feature within an image generated by the rear view camera to an actual position of the at least one distinguishable vehicle feature within the image.

In addition to one or more of the features described herein the at least one distinguishable vehicle feature includes a taillight.

In addition to one or more of the features described herein the camera position and orientation monitoring subprocess is further configured to crop the image prior to comparing the expected position of the at least one distinguishable vehicle feature within the image generated by the rear view camera to the actual position of the at least one distinguishable vehicle feature within the image.

In another exemplary embodiment a method for monitoring an image generated by a rear facing side mounted camera includes operating a plurality of quality assurance subprocess in real time and configured to cause the controller to notify the driver in response to at least one quality control metric determination. The plurality of quality assurance subprocesses include a frozen image monitoring subprocess, a camera position and orientation monitoring subprocess, and a latency monitoring subprocess.

In addition to one or more of the features described herein the frozen image monitoring subprocess determines a semantic similarity between a first image and a subsequent image using a frozen image subprocess including providing the first image as an input to a first neural network and providing the second input to a second neural network and comparing an output of the first neural network to an output of the second neural network.

In addition to one or more of the features described herein the first neural network and the second neural network are identically trained neural networks having exactly the same parameters and the same weights for those parameters.

In addition to one or more of the features described herein the output of the first neural network is a first vector and the output of the second neural network is a subsequent vector.

In addition to one or more of the features described herein the subsequent image is immediately subsequent the first image.

In addition to one or more of the features described herein the subsequent image is subsequent to the first image by a delay of a plurality of intervening images.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a schematic representation of a vehicle including a side mounted rear view camera system;

FIG. 1B is a perspective view of the side mounted rear view camera system from a driver's point of view;

FIG. 2 is a monitoring process for ensuring an image presented by the rear view camera system to the driver is not frozen;

FIG. 3 is an exemplary method of comparing subsequent images in the process of FIG. 2 using machine learning;

FIG. 4 is an exemplary process for monitoring latency of an image presented by the rear view camera system; and

FIG. 5 is an exemplary process for monitoring a position and orientation of a camera using an image presented by the rear view camera.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the terms controller and control system refer to dedicated individual controllers, general controllers including control modules dedicated to specific purposes, software systems within general controllers, networks of controllers in communication with each other and configured to operate cooperatively to control one or more system, and/or any similar configuration of processors and memory systems able to implement a control process.

In accordance with an exemplary embodiment, a vehicle includes one or more side mounted rear view camera systems. The rear view camera systems can be in addition to, or instead of, rear facing side mirrors and provide a similar view to the vehicle's driver using a corresponding screen mounted in the interior of the vehicle. In order to ensure that the image presented to the driver can reliably be utilized in place of, or in supplement to, a side mirror, a controller within the vehicle monitors the image feed from the camera(s) by running quality assurance processes on the image feed. The quality assurance process includes multiple concurrent subprocesses. In one example, the quality assurance subprocesses include a process for ensuring that the image is not frozen, a process for ensuring that the latency of the image is below an acceptable latency magnitude, and a process for ensuring that the field of view captured by the camera(s) has not shifted.

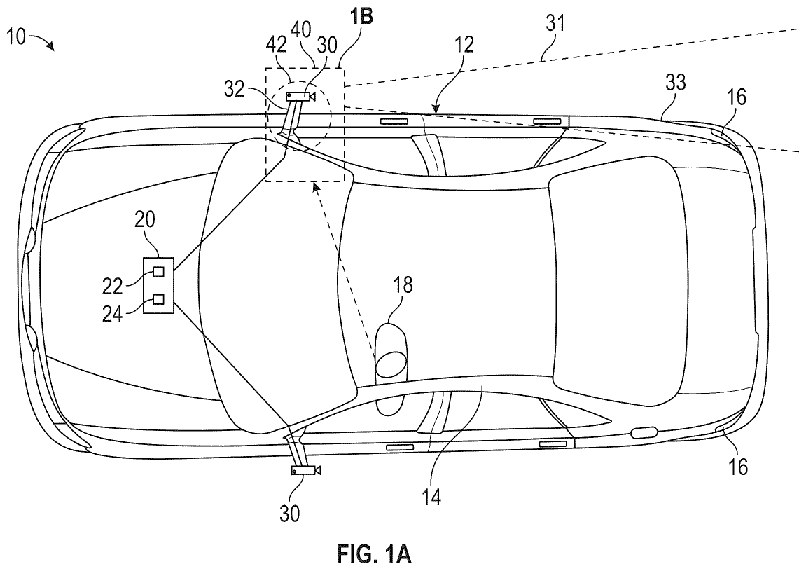

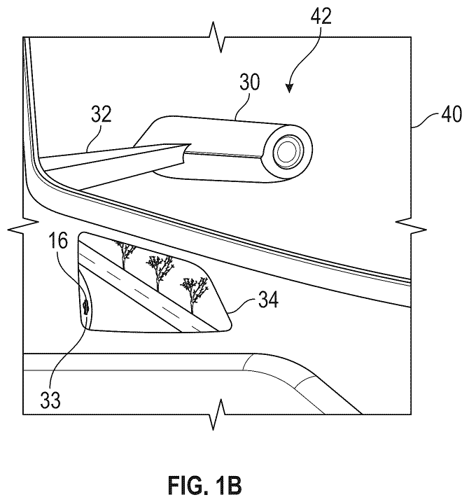

FIG. 1A is a top down schematic representation of a vehicle 10, including a body 12 and a passenger compartment 14. FIG. 1B illustrates a perspective view 40 of a side mounted rear view camera system 42 from the point of view of a driver 18. The body 12 includes tail lights 16 disposed on a rear portion of the vehicle 10. The driver 18 is seated in a drivers position of the passenger compartment 14. The rear view camera system 42 is configured to provide the driver 18 with views replicating those provided by traditional side mounted rear view mirrors.

The rear view camera system 42 includes cameras 30 mounted to the body 12 of the vehicle 10 via wings 32. The cameras 30 generate corresponding rear facing fields of view 31. Due to the positioning of the cameras 30, the rear facing fields of view 31 include a corresponding portion 33 of the vehicle body 12. In the example of FIG. 1A, the corresponding portion 33 includes the taillights 16. In alternative examples where the taillights 16 are not within the fields of view 31, the vehicle body 12 may include markings or other features on the corresponding portion 33 with the markings or other features having a fixed position relative to the body 12 such that the markings or other features do not move relative to the camera and will always appear at a fixed position in the generated image.

A controller 20 includes a memory 22 and a processor 24 and is connected to each camera 30. While illustrated in the example of FIG. 1A as being a dedicated controller, it is understood that the controller 20 may include additional features and elements for providing additional control of one or more systems within the vehicle 10. By way of example, the controller 20 may include motor controls for articulating the wings 32 and/or actuators within the wings 32, thereby allowing the controller 20 to adjust the position and angle of the cameras 30 relative to the vehicle body 12.

In addition, the controller 20 is configured to output processed images generated from the cameras 30 to a screen 34 allowing the driver 18 to view the generated images in real time.

Included within the memory 24 are one or more modules containing subprocesses for monitoring the images generated by the cameras 30 and presented to the driver 18 on the screen 34. The monitoring continuously tests the functionality of the cameras 30 and detects any problems that may reduce the functionality of the corresponding camera 30 in real time by running multiple concurrent subprocesses on the controller 20. The detectable problems can include camera freeze, unacceptably high latency and/or camera misalignment among other possible detections. When such a problem is detected, the controller 20 issues a corresponding warning or notification to the driver 18 via one or more onboard systems (e.g., the screen 34) notifying the driver 18 of the loss of, or reduction in, functionality. In some cases the controller 20 further includes one or more modules configured to adjust positioning and/or angle and orientation of the cameras 30 to correct for or mitigate a reduction in functionality after the reduction has been detected.

The controller 20 is configured to provide the images generated by the cameras 30 to additional vehicle systems, such as driver assist systems, object recognition systems, pedestrian detection systems, and the like. The controller 20 is further configured to notify the additional systems of the loss of, or reduction in, functionality when detected. Upon notification, the additional systems can take any corresponding remedial actions as may be warranted by the particular additional system.

During general operation the camera 30 captures an image of the environment within its field of view 31. The captured image is corrected by the controller 20 to account for any distortions due to camera lens shape, angle, positioning etc. and prepared for display on the screen 24 using image processing systems. One or more machine learning algorithms are utilized to compare the dynamic components in two consecutive (or sequential) images to detect camera freeze. In addition, the tail light 16 (or another vehicle body 12 feature) is always visible within the image, and should be at a fixed position in the image. This knowledge is used to detect misalignment or shifting of the image by determining how far the actual position of the tail light 16 is from the expected position of the tail light 16. In another monitoring subprocess, an expected frequency of images is compared to an actual received frequency to monitor a latency of the video feed provided by the camera 30.

In some cases the above process may be impacted by taillight 16 flickering that, while not visible to the human eye, is distinguishable at the capture speeds of the cameras 30. To prevent tail light flicker from impacting the monitoring subprocesses that compare the images, the signal processing performed on the image includes imposing a solid block of color over the taillight 16. This prevents taillight flicker from inadvertently providing inaccurate results. After the monitoring subprocesses, and before displaying the images on the screen 34, the superimposed solid block of color is removed from the image.

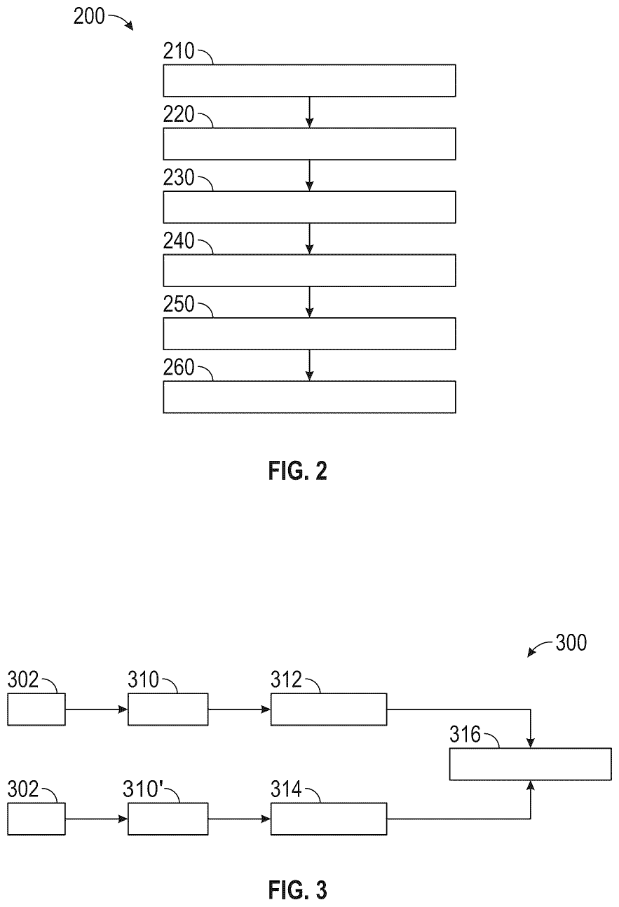

With continued reference to FIGS. 1A and 1B, FIG. 2 illustrates a process 200 for determining if the image is frozen as one of the concurrent subprocesses used to monitor the image feed from the camera 30. Initially, the camera 30 generates a first image (image A) and provides the image to the controller 20 in a receive image A step 210. Image A is temporarily stored in the memory 24 in a buffer image A step 220. Subsequently, a next image (image B) is provided from the camera 30 to the controller in a receive image B step 230.

After receiving image B, image A and Image B are pre-processed in a process images step 240 using image processing techniques stored in the memory 24. The image processing is performed according to existing image processing techniques and prepares the images for display to the driver via the screen 34. Among other processing steps, during the process images step 240 images A and B are corrected for distortions using a calibration setup.

Once processed, images A and B are compared to determine their similarity at a compare image A to image B step 250 (illustrated in more detail at FIG. 3). For the purposes of process 200, images A and B are considered similar when the images vary only in terms of contrast, brightness and rotation. This level of similarity can alternatively be referred to as being semantically identical. Semantically identical images depict the same objects in the same positions.

In order to determine whether the images represent a static image (e.g. a frozen image output from the camera 30) and not merely similar scenes (e.g., subsequent images on a long straight stretch of empty road), the processed images are compared using a machine learning process such as a Deep Neural Network (DNN) to determine semantic identicality.

With continued reference to FIG. 2, FIG. 3 illustrates a process flow 300 of the machine learning comparison of step 250. Initially, image A and image B (images 302) are provided to a twin network 310 which compares the images 302 in real time.

The twin network 310 is a neural network that includes two identical subnetworks (DNN, twin networks 310, 310'). Each of the identical subnetworks contain exactly the same parameters and the same weights for those parameters. The subnetworks 310, 310′ can be any neural network configured for image analysis. In one example, the DNN subnetworks 310, 310′ are convolutional neural networks. In other examples, other types of neural networks may be utilized to similar effect. Each subnetwork 310, 310′ receives the corresponding image 302 as an input and outputs a vector 312, 314. The vectors 312, 314 are then compared in a compare vector step 316 to determine how similar the images 302 are. Semantically identical images will have identical image vectors 312, 314 allowing for the controller to easily distinguish between superficially similar scenes resulting from minimally changing backgrounds and semantically identical images resulting from a frozen camera image.

Referring again to FIG. 2, when the compared vectors 312, 314 are identical, the images 302 are semantically identical and a frozen image is detected. This detection results in a notification to the driver 18 in a notify operator step 260. In some examples, the notify operator step 260 further includes notifying one or more additional vehicle systems, such as driver assist systems, pedestrian recognition systems, and the like, that the image is frozen. In such cases, the additional vehicle systems are configured with appropriate responses to a frozen image. The appropriate responses depend on the particular additional vehicle system and can include responses such as utilizing a last known valid image, removing the camera 30 providing the frozen image from a set of vision sensors, disabling the additional vehicle system, and/or any similar responses.

In the example process 200, image A 302 and image B 304 are immediately subsequent to each other in the image feed from the corresponding camera 30. In alternative examples a delay between the compared images may be introduced by spacing the compared images apart via some number of additional images between the compared images. Such a delay may be desirable when minimal variation is expected image to image, and a delay may enhance the ability of the controller 20 to detect a frozen image.

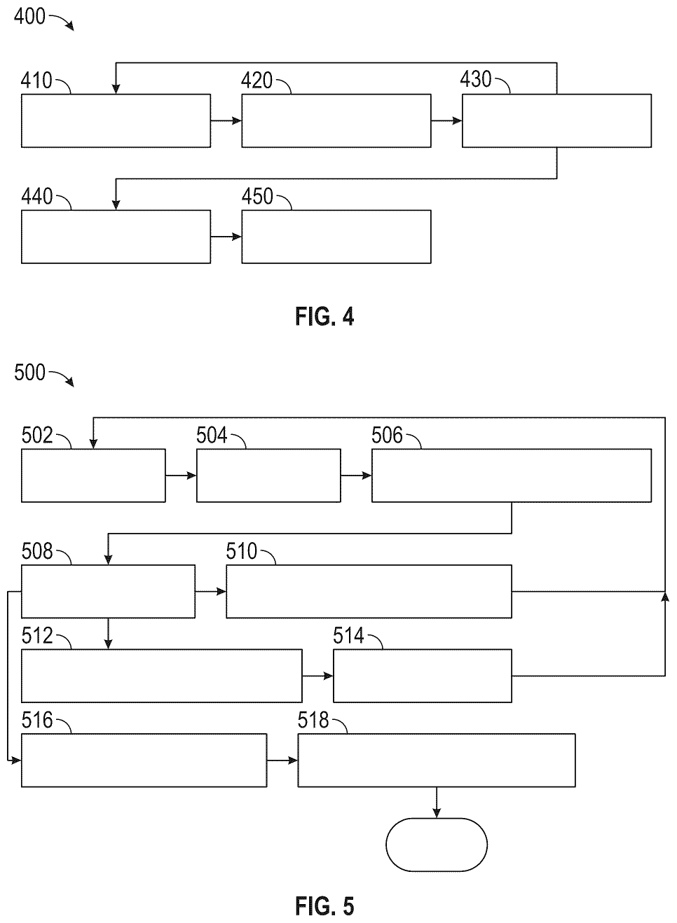

With reference to FIG. 4, concurrent with the process 200 for determining if an image is frozen, the controller 20 performs a process 400 for determining a latency of an image stream provided from a camera 30. The process 400 operates based on an underlying understanding that, when operating at peak operation a camera 30 will provide a known number of images to the controller within a set time frame. By way of example, if the camera 30 has a capture rate of 180 images per second, then the controller 20 should receive 180 images within any given one second time period. Latency is a measure of how reduced the actual number is from the expected number.

When initiated by the controller 20, the process 400 begins operating at receipt of a first image in a receive image step 410. In a first loop of the process 400, the controller 20 responds to the receipt of the first image by initiating a timer. In addition, upon receipt of the image at step 410, a counter is incremented in an increment counter step 420. After incrementing the counter, the process 400 checks how much time has elapsed in a check timer step 430.

When the timer is under a threshold time, e.g. one second, the process 400 returns to the receive image step 410 and awaits a new image. Once the new image is received a subsequent looping of the process 400 begins at the receive image step 410.

When the timer is equal to the threshold time or exceeds the threshold time,, the process 400 proceeds from the check timer step 430 to a compare counter to expected count step 440. In the compare counter to expected count step 440 the controller identifies the number of images that were received within the time threshold as the value of the counter and compares the value of the counter to a known expected number of images. In the example where 180 images per second is the expected rate, the expected count is 180 for a one second time period.

Based on this comparison a latency of the image feed is determined, and a corresponding latency warning is output to the driver 18. In one example, the latency can be set at multiple levels of acceptability, with corresponding warnings. In this example, a latency of 90% or higher (meaning that 90% or more of the expected image count is received within the time frame) is considered good and no warning is output. A latency of between 70% and 90% is considered acceptable, but slow, and the image feed can continue to be utilized provided the operator is informed. In this case a warning is provided to the operator identifying that the image feed is laggy. A latency below 70% is considered unacceptably slow and the image feed cannot be used. In such a case, a warning is provided to the driver 18 identifying that the image feed is unacceptably laggy and the screen 34 ceases displaying the image. The latency numbers and ranges identified herein are exemplary in nature. Practical implementations will utilize alternative numbers and ranges depending on the particulars of the vehicle 10.

The latency warning can be provided to the driver 18 directly on the screen 34 used to display the corresponding image feed, provided to the driver 18 on one or more auxiliary screens within the vehicle, or a combination thereof. In addition, the latency warning can be a combination of audio visual warnings including text overlays on the screen 34, symbolic warnings, or any other suitable human machine interface.

In some implementations multiple subsequent iterations of the process 400 can be analyzed by the controller 20 to provide further context, and thus inform the latency warnings. By way of example, if the subsequent iterations of the process 400 indicate that the latency is increasing (meaning that less images are being received in the time period in each subsequent iteration), a corresponding warning can be preemptively provided to the driver 18 before the latency reaches unacceptable levels thereby allowing the driver 18 to take any necessary or appropriate remedial actions before the image feed becomes unreliable.

Alternatively, when the latency is improving the controller 20 may apply a lower threshold of acceptability, allowing for an image feed that has an improving latency to continue to be used even though the image feed may currently be below the acceptable level.

Simultaneously with the subprocesses 200, 400 the controller 20 ensures that the camera 30 is in a correct position and orientation in a position monitoring subprocess 500. FIG. 5 illustrates an example subprocess 500 for monitoring the position and orientation of the camera 30 based on an expected positioning of one or more features within the received image.

The subprocess 500 is able to be operated on a single received image. However, in some examples, the subprocess 500 can be reiterated on subsequent images with the outputs being combined (e.g., by averaging) in order to verify the accuracy of the results.

Initially the controller 20 receives an image from the camera 30 in a receive image step 502. The recieved image undergoes an initial image processing sequence in a process image step 504.

The fixed features are rigidly mounted to, or portions of, the vehicle 10 and are discernible using automated image analysis. Based on the expected position and orientation of the camera 30, the controller 20 is able to identify where in the received image the fixed features are expected to occur, and the controller crops the image to a smaller section immediately surrounding the expected position of the one or more fixed features, such as the taillight 16, in a crop to feature coordinates step 506. Cropping the received image reduces the amount of the image utilized in the subsequent steps, thereby reducing a computational load of the subprocess 500 and increasing a speed at which the subprocess 500 can be completed.

After cropping the image to the area in which the fixed features are expected to appear, the cropped image is compared to a target image in a compare to target step 508. The target is a precise location within the received image where the fixed features are expected to appear based on the expected angle and position of the camera 30. The comparison determines deviation from the expected position in number of pixels, and the deviation is then compared to a target threshold and a maximum threshold.

When the variation is less than the target threshold (check 510), the controller 20 determines that the camera 30 is within an acceptable range of the desired position and orientation and that any variation is inconsequential. By way of example, such variation may the result of vehicle vibrations, slight misalignments, etc. When the check 510 is passed, the subprocess 500 returns to the receive image step 502, and is ready to run again.

When the variation is greater than or equal to the target threshold, but less then a maximum threshold (check 512), the controller 20 determines that the camera 30 is out of position and attempts to correct the position in an engage correction step 514. In some examples, the controller 20 engages the correction by activating control mechanisms such as actuators within the wing 32 and camera 30. The control mechanisms adjust the positioning and angle of the camera 30. The magnitude and orientation of the adjustments can be determined by the controller 20 based on the variation according to known techniques.

Once adjusted, the subprocess 500 returns to the receive image step 502 and immediately reengages to determine if the adjustment adequately corrected the positioning.

When the compare to target step 508 determines that the variation is above the target threshold and above a maximum threshold (check 516) or when the compare to target step 508 determines that a previous iteration's attempt to engage corrections did not correct the position and/or orientation of the camera 30, the subprocess 500 warns the operator and any additional systems that rely on the images from the camera 30 that the camera 30 is out of position and should not be relied on in a warn operator and controller step 518. After warning the operator and any additional systems, the controller 20 ends the subprocess 500 until a new engine cycle begins.

By monitoring the image feed using the quality assurance subprocesses, the controller 20 is able to ensure that accurate and reliable images are provided to the driver 18, and that the driver 18 is notified when the camera 30 is unable to provide reliable images.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a rear view camera system including a camera mounted to a side of the vehicle, the camera defining a rear facing field of view, a screen viewable from a position of a driver in the vehicle and configured to display an image feed captured by the camera, and wherein at least a portion of the vehicle is within the rear facing field of view, the portion of the vehicle within the rear facing field of view including at least one distinguishable vehicle feature fixedly mounted to the vehicle relative to the rear view camera; and
a controller including a memory and a processor, the memory storing instructions configured to cause the controller to operate at least one quality assurance subprocess in real time and configured to cause the controller to notify the driver in response to at least one quality control metric determination.

2. The vehicle of claim 1, wherein the at least one quality assurance subprocess includes a frozen image monitoring subprocess.

3. The vehicle of claim 2, wherein the frozen image monitoring subprocess is configured to determine a semantic similarity between a first image and a subsequent image using a frozen image subprocess.

4. The vehicle of claim 3, wherein the subsequent image is immediately subsequent the first image.

5. The vehicle of claim 3, wherein the subsequent image is subsequent to the first image by a delay of a plurality of intervening images.

6. The vehicle of claim 3, wherein the frozen image subprocess includes providing the first image as an input to a first neural network and providing the second input to a second neural network and comparing an output of the first neural network to an output of the second neural network.

7. The vehicle of claim 6, wherein the first neural network and the second neural network are identically trained neural networks having exactly the same parameters and the same weights for those parameters.

8. The vehicle of claim 6, wherein the output of the first neural network is a first vector and the output of the second neural network is a subsequent vector.

9. The vehicle of claim 1, wherein the at least one quality assurance subprocess includes a latency monitoring subprocess configured to detect a latency of an image feed provided from the camera by comparing an expected number of images in the image feed during a predetermined time window to an actual number of images received at the controller from the camera in the predetermined time window.

10. The vehicle of claim 9, wherein the latency monitoring subprocess is configured to cause the controller to notify the driver in response to a latency exceeding an acceptable latency threshold.

11. The vehicle of claim 1, wherein the at least one quality assurance subprocess includes a camera position and orientation monitoring subprocess configured to detect a deviation of the actual position and orientation of the camera from an expected position and orientation of the camera.

12. The vehicle of claim 11, wherein the camera position and orientation monitoring subprocess is configured to detect a deviation of an actual camera position and orientation from an expected camera position and orientation by comparing an expected position of the at least one distinguishable vehicle feature within an image generated by the rear view camera to an actual position of the at least one distinguishable vehicle feature within the image.

13. The vehicle of claim 12, wherein the at least one distinguishable vehicle feature includes a taillight.

14. The vehicle of claim 13, wherein the camera position and orientation monitoring subprocess is further configured to crop the image prior to comparing the expected position of the at least one distinguishable vehicle feature within the image generated by the rear view camera to the actual position of the at least one distinguishable vehicle feature within the image.

15. A method for monitoring an image generated by a rear facing side mounted camera, the method comprising:
operating a plurality of quality assurance subprocess in real time and configured to cause the controller to notify the driver in response to at least one quality control metric determination; and
wherein the plurality of quality assurance subprocesses include a frozen image monitoring subprocess, a camera position and orientation monitoring subprocess, and a latency monitoring subprocess.

16. The method of claim 15, wherein the frozen image monitoring subprocess determines a semantic similarity between a first image and a subsequent image using a frozen image subprocess including providing the first image as an input to a first neural network and providing the second input to a second neural network and comparing an output of the first neural network to an output of the second neural network.

17. The method of claim 16, wherein the first neural network and the second neural network are identically trained neural networks having exactly the same parameters and the same weights for those parameters.

18. The method of claim 16, wherein the output of the first neural network is a first vector and the output of the second neural network is a subsequent vector.

19. The method of claim 16, wherein the subsequent image is immediately subsequent the first image.

20. The method of claim 16, wherein the subsequent image is subsequent to the first image by a delay of a plurality of intervening images.
